(19) United States
(12) Patent Application Publication
(10) Pub. No.: US 2008/0233025 A1
(43) Pub. Date: Sep. 25, 2008

(54) METHOD AND SYSTEM FOR RECOVERING SULPHUR FROM GAS STREAMS

(76) Inventor: John Keum-Ho Hwang, Calgary (CA)

Correspondence Address: SEAN W. GOODWIN, 222 PARKSIDE PLACE, 602-12 AVENUE S.W., CALGARY, AB, T2R 1J3, CA

(21) Appl. No.: 11/761,261

(22) Filed: Jun. 11, 2007

(30) Foreign Application Priority Data
Oct. 31, 2006 (CA) 2568303

(51) Int. Cl. B01D 53/86; G05B 11/00

(52) U.S. Cl. 423/224; 422/105; 422/169; 423/222

(57) ABSTRACT

There is described a novel process for removing sulphurous compounds from industrial gaseous streams, such as sour gas, using an oxygen deficient environment during the oxidation of H₂S, and further recycling of any unconverted H₂S back to a regenerator.

### FIELD OF THE INVENTION

The present invention relates generally to recovery of sulphur from oil and gas processing, and more particularly to the removal of sulphurous compounds from gaseous streams produced during industrial processes, thereby releasing “clean gas” containing minimal amounts of sulphurous compounds.

### BACKGROUND OF THE INVENTION

A hazard associated with the petroleum industry is the atmospheric release of the toxic gas hydrogen sulphide (H₂S). H₂S is found in various gas streams, such as raw sour gas streams or in gas streams (such as tail gas streams) arising from industrial operations where fuels containing sulphur and other combustible materials are burned. H₂S, being extremely toxic, must in accordance with regulations be removed before the by-products from such industrial operations can be released into the atmosphere. Regulations have necessitated the development of methodologies to recover sulphur and reduce the amounts of each of H₂S and SO₂ released into the atmosphere.

Conventionally, the amount of sulphur released into the atmosphere is reduced by converting H₂S and SO₂ into elemental sulphur. The method commonly used by industry today is known as the modified Claus process, first developed by the London chemist Carl Friedrich Claus in 1883. This method is based on the Claus reaction:

2H₂S+SO₂ [symbol] ⅜S₈+2H₂O (1)

The modified Claus process is a two step process: 1) the oxidation of H₂S to SO₂ in a reaction furnace according to the equation:

H₂S+⅜O₂→SO₂+H₂O (2)

and 2) the reaction of SO₂ and residual H₂S into elemental sulphur via the Claus reaction (1). The second step, the reaction of H₂S and SO₂ into elemental sulphur is typically completed using a series of catalytic reactors, because the Claus reaction is an equilibrium reaction. Consequently, it is typical to use several catalytic reactors in series, with elemental sulphur incrementally removed at each reactor, to achieve greater sulphur recovery.

Unfortunately, thermodynamically, one does not recover all the sulphur by employing only a series of Claus reactors. A small amount of H₂S remains in the tail gas stream, thereby necessitating the additional step of tail gas clean up (hereinafter “TGCU”).

There are a total of 16 TGCU processes known to be in use, 9 of which are proven technologies. TGCU units are typically used together with either Claus or modified Claus sulphur recovery units (hereinafter “SRU”).

A typical SRU involves a raw gas feed stream passing through an amine treating unit that absorbs H₂S and then desorbs it, thereby concentrating the H₂S. This concentrated H₂S then enters a reaction furnace where it is combusted in an oxygen rich environment, producing H₂S and SO₂ in accordance with reaction (3) below.

H₂S+aO₂bH₂S+cSO₂+dS₍ₑₗₑₘₑₙₜₐₗ₎+e COS+fCS₂+gH₂O (3)

Elemental S and H₂O are then removed from the partially treated gas stream by condensation that lowers the temperature of the gas stream, which is then passed through a series of catalytic converters where COS, CS₂, and elemental S are removed. H₂S and SO₂ undergo the Claus reaction (1) above, while COS and CS₂ mainly undergo different reactions (4) and (5) to produce H₂O and elemental sulphur.

COS+H₂O→CO₂+H₂S (4)

CS₂+2H₂O→CO₂+2H₂S (5)

Disadvantageously, after a series of catalytic converters progressively remove sulphur from the gas stream, the use of catalytic converters is no longer efficient, so a small portion of the original H₂S and produced SO₂ are released into the atmosphere with the treated exhaust.

The following known patents teach different improvements to the above conventional method of removing sulphurous compounds from industrial gas streams.

U.S. Pat. No. 4,138,473 to Gieck (the '473 patent, issued Feb. 6, 1979) teaches the use of pure oxygen to combust H₂S into SO₂. Further, the use of three catalytic converters in series is combined with the repressurization and reheating of the gas stream before entering the next catalytic converter in the series, each converting H₂S and SO₂ into H₂O and elemental sulphur. SO₂ is then recycled back to the start of the process as fuel for use in the Claus reaction (1). The '473 patent further teaches that the stoichiometric ratio between H₂S and SO₂ maintained at 2:1 offers maximum efficiency. Disadvantageously, the '473 technology depends on an oxygen rich environment for its oxidation of H₂S, leading to uncontrolled combustion of H₂S, resulting in an excess of SO₂ needing to be reduced to elemental sulphur by the catalytic converters. This excess production of SO₂ also requires a TGCU unit to scrub out the excess SO₂, thereby higher cost.

U.S. Pat. No. 4,895,670 to Sartori (issued Jan. 23, 1990) and U.S. Pat. No. 4,961,873 to Ho (issued Oct. 9, 1990) each teach the use of an amine scrubber to absorb H₂S and concentrate it prior to entering the reaction furnace 130 (with reference to FIG. 1). Disadvantageously, neither of these patents overcomes the necessity of using a TGCU unit.

U.S. Pat. No. 4,071,436 to Blanton (issued Jan. 31, 1978) teaches the use of various catalysts (e.g. alumina, typically in a fluidized bed or embedded on the surface of a moving bed) in a converter to help drive the Claus reaction (1). Disadvantageously, these technologies still require the use of a TGCU before the exhaust gases can be released to atmosphere.

An oxygen rich environment has been typical of conventional sulphur recovery until recently. However, US Patent Application 2005/0158235 to Ramani, (published Jul. 25, 2005) teaches the limited use of oxygen during the oxidation of H₂S to lower the SO₂ introduced to subsequent stages and thereby in the exhaust. Disadvantageously, US Application 2005/0158235 necessitates the use of a TGCU unit to remove residual SO₂ in the exhaust.

US Patent Application 2006/0078491 to Lynn (published Apr. 13, 2006) teaches treating a gas stream using an excess of SO₂ within an organic liquid environment such as poly glycol ether (or other tertiary amine solution), according to a process in which the stoichiometric ratio between H₂S and SO₂ should be maintained lower than 2:1. This process eliminates the need for an amine scrubber and absorber. Disadvantageously, this also results in a higher concentration of SO₂ entering the catalytic converters, which SO₂ must be recycled back to the start of the process as fuel for use in the Claus reaction (1), like the process taught in '473.

It is, therefore, desirable to provide a less costly methodology for recovering sulphur from sour gas streams, which process does not necessitate the use of a TGCU unit in order to meet modern environmental standards.

### SUMMARY OF THE INVENTION

It is an object of the present invention to eliminate the need for a TGCU unit when recovering sulphur from sour gas streams.

In one broad aspect of the invention, a process for removing sulphurous compounds including H₂S from an industrial gas stream is provided comprising the steps of: feeding the industrial gas stream into a reaction furnace; combusting the industrial gas stream so as to oxidize H₂S therefrom in said furnace under sufficiently oxygen-deficient conditions so as to maintain a stoichiometric ratio between H₂S and SO₂ to be greater than 2:1; condensing the combusted gas stream so as to precipitate H₂O and elemental sulphur therefrom; converting the remaining products from the combustion of H₂S to elemental sulphur, using a conventional modified Claus reactor; condensing the catalyzed gas stream so as to further precipitate H₂O and elemental sulphur therefrom; scrubbing unconverted H₂S out of the treated gaseous stream and concentrate using a secondary regenerator; and recycling any unconverted H₂S to a reaction furnace. Preferably, the industrial gas stream is pre-scrubbed in a pre-existing primary amine treatment unit.

Another object of the present invention is to take advantage of an oxygen deficient environment that exists inside a typical reaction furnace. The method of present invention uses such oxygen deficient environment to control the stoichiometric ratio between the H₂S and SO₂ entering the catalytic converters, and then recycles residual H₂S back to an amine treating unit.

Thermodynamically, the Claus reaction (1) is an equilibrium reaction the dissociation constant of which is:

Kₚ=[S₈]^{3/8}[H₂O]²/[H₂S]²[SO₂] (6)

According to a method of the present invention a gas feed stream first enters an amine treating unit in order to concentrate the H₂S in that raw stream. The concentrated H₂S then enters a reaction furnace where it is subjected to an oxygen deficient environment, which in turn results in less SO₂ leaving the furnace, such that the stoichiometric ratio between H₂S and SO₂ is greater than 2:1.

The concentrated H₂S in the primary gas stream entering the furnace is oxidized according to combustion reaction (3) thereby producing SO₂, H₂S, COS and CS₂ and H₂O. This is a complete reaction, only dependant upon the availability of the reactants, H₂S and O₂. Advantageously, limiting the amount of O₂ present during the combustion of H₂S results in a lower production of the by-product SO₂ needing to undergo catalytic conversion.

In accordance with the dissociation equation (6), a high concentration of H₂S necessarily produces a low concentration of SO₂, since at a constant temperature the concentration of SO₂ is inversely proportional to the concentration of H₂S squared. In an oxygen-deficient environment the Claus reaction (1) produces a higher concentration of H₂S and a lower concentration of SO₂ as compared to the modified Claus reaction, which produces H₂S and SO₂ in a stoichiometric ratio of 2:1.

H₂O and elemental sulphur precipitate out of the gas stream by condensation. COS and CS₂ continue along in the gas stream and enter a catalytic converter where they are subjected to reactions (4) and (5) to produce H₂O and elemental sulphur. The H₂S and SO₂, (in said stoichiometric ratio greater than 2:1) also enter a catalytic converter, where the Claus reaction (1) produces H₂O and elemental sulphur.

Residual H₂S is removed by a secondary amine scrubber and recycled back to primary regenerator to increase the amount of H₂S available for oxidation in the furnace. In an alternative embodiment, residual H₂S may be removed by the secondary amine scrubber, regenerated by a secondary regenerator, and recycled to the reaction furnace. It should be noted that the primary amine scrubber and regenerator are not part of the proposed sulphur recovery unit, but part of a pre-existing amine treating unit (hereinafter “ATU”).

An embodiment of the process of this present invention for removing sulphurous compounds, from an industrial gas stream flowing through a fluidly coupled system comprises a primary scrubber (of a pre-existing ATU), a primary regenerator (of a preexisting ATU), a reaction furnace, suitable controllers and sensors, at least two condensers, at least one catalytic converter, and a secondary scrubber.

The primary scrubber and primary regenerator scrubs H₂S from the industrial gaseous stream and concentrates the H₂S. The concentrated H₂S enters the reaction furnace under oxygen deficient conditions and is oxidized. The oxidized gas stream enters a condenser to precipitate out H₂O and elemental sulphur. The remaining gases, are catalyzed in a conventional modified Claus reactor to further produce elemental sulphur and H₂O. Any unconverted H₂S is further scrubbed by the secondary scrubber and then recycled through the primary regenerator to re-enter the reaction furnace.

One embodiment of the system of this present invention for removing sulphurous compounds, from an industrial gaseous stream flow, comprises a primary scrubber and a primary regenerator, both of a pre-existing ATU. These are to scrub and concentrate H₂S from an industrial gaseous stream.

The system further comprises a reaction furnace, to oxidize the concentrated H₂S, condensers to precipitate out elemental sulphur and H₂O, a conventional modified Claus reactor, suitable sensors and controllers and a secondary scrubber. The system also recycles the scrubbed H₂S back to the primary regenerator.

The accompanying drawings, which are incorporated in and constitute a part of this specification, illustrate preferred embodiments of the method and system according to the invention and, together with the description, serve to explain the principles of the invention.

### BRIEF DESCRIPTION OF THE DRAWINGS

The present invention, in order to be easily understood and practiced, is set out in the following non-limiting examples shown in the accompanying drawings, in which:

FIG. 1 is a schematic diagram illustrating a preferred embodiment of the system of the invention;

FIG. 2 is a schematic diagram illustrating an alternate embodiment of the system of the invention incorporating a stabilizer;

FIG. 3 is a flow chart demonstrating the preferred embodiment of the process;

FIG. 4 is a schematic diagram illustrating an alternate embodiment of the system of the invention incorporating a secondary regenerator;

FIG. 5 is a flow chart demonstrating an alternate embodiment of the process incorporating a secondary regenerator;

FIG. 6 is a schematic diagram of the preferred embodiment of the invention demonstrating the mathematical relationship existing between each step of the process; and

FIG. 7 is a table demonstrating sulphur recovery according to Example 1.

### DETAILED DESCRIPTION OF THE PREFERRED EMBODIMENTS

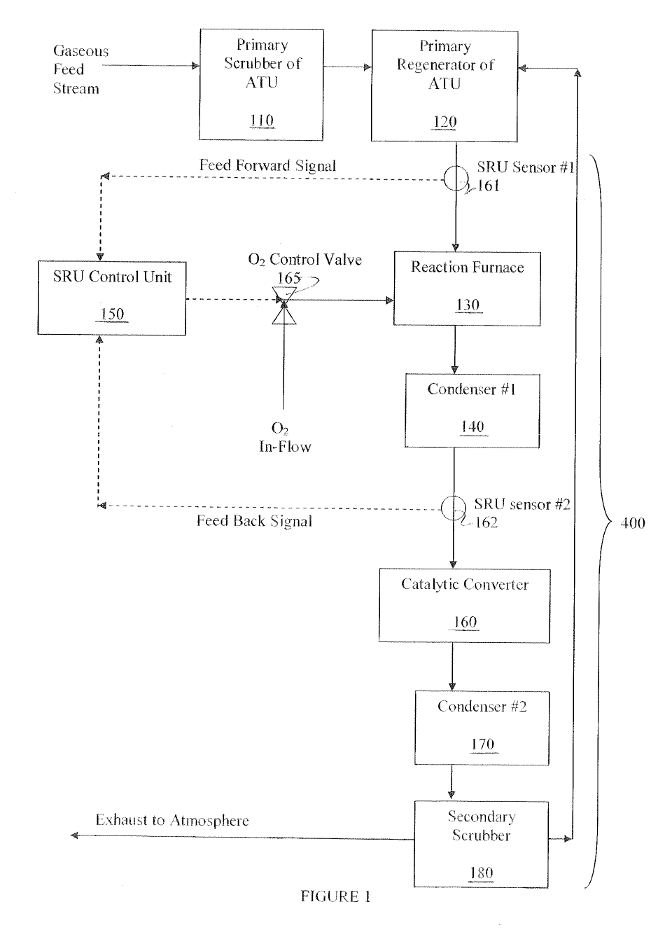

Referring to FIG. 1, there is illustrated one embodiment of a system, the sulphur recovery unit (hereinafter “SRU”) denoted generally as 400, in which a primary gas feed stream enters primary scrubber (of a pre-existing ATU) 110 where H₂S is absorbed from the gas stream and is thereafter concentrated in primary regenerator (of a pre-existing ATU) 120, such that purified and concentrated H₂S enters reaction furnace 130. The SRU sensor #1 161, monitors the amount of H₂S entering furnace 130 and provides a feed forward signal to SRU control unit 150, which regulates the amount of air entering furnace 130 via O₂ Control Valve 165, so as to maintain an oxygen-deficient environment and achieve the designed combustion of H₂S.

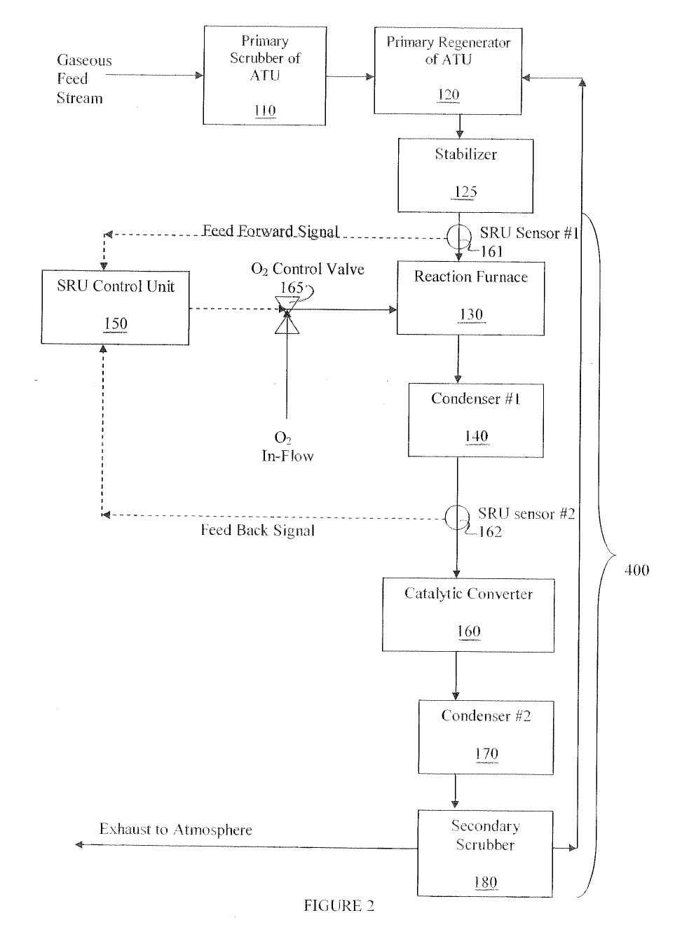

As shown in FIG. 2, the purified and concentrated H₂S can be stabilized inside a stabilizer 125 prior to enter the reaction furnace 130.

H₂S is oxidized by O₂ in furnace 130 to produce gaseous forms of elemental sulphur, H₂O, COS, CS₂, and SO₂. All products then enter condenser #1 140. Inside condenser #1 140, the gas stream temperature is lowered sufficiently that H₂O and elemental sulphur precipitate out, leaving the gaseous form of each of COS, CS₂, H₂S and SO₂ to flow into catalytic converter 160, which is any suitable conventional catalytic converter.

SRU sensor #2 162 measures the amount of H₂S and SO₂ entering catalytic converter 160 and also sends a feed back signal to SRU control unit 150, which combines that signal with the feed forward signal from SRU sensor #1 161 in order to regulate the amount of air entering furnace 130, and thereby the results of oxidation reaction (3), by maintaining the stoichiometric ratio between H₂S and SO₂ at greater than 2:1, such that a controlled amount of SO₂ is produced during the initial oxidative process in furnace 130.

Inside catalytic converter 160 the reactants undergo the Claus reaction (1) to produce elemental sulphur, COS, CS₂, and H₂O. COS and CS₂ also undergo reactions (4) and (5) to further produce H₂O and elemental sulphur. Any suitable catalyst may be used to facilitate the Claus reaction. Maintaining the stoichiometric ratio between H₂S and SO₂ at greater than 2:1 advantageously controls the amount of H₂S and SO₂ entering catalytic converter 160, which is achieved by SRU control unit 150 using feed back signals from SRU sensor #2 162 monitoring the amount of H₂S and SO₂ entering catalytic converter 160.

The treated gas stream leaving catalytic converter 160 enters condenser #2 170 to further precipitate out both H₂O and elemental sulphur. After which, the treated gas stream leaving condenser #2 170 flows into a downstream secondary scrubber 180 where excess H₂S is absorbed and any unconverted H₂S is recycled back to primary regenerator 120.

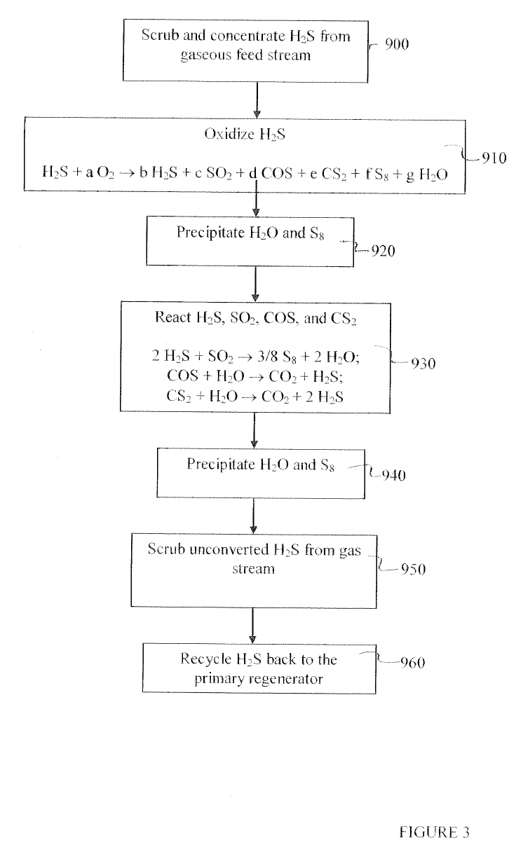

As illustrated in the flow chart of FIG. 3, the process conducted in the system of FIGS. 1 and 2 comprises scrubbing and concentrating H₂S from a gaseous feed stream at 900. The scrubbed H₂S then is oxidized at 910 according to the present invention. Water and elemental sulphur are precipitated at 920. H₂S, SO₂, COS and CS₂ are reacted at 930. Water and elemental sulphur are precipitated at 940. Unconverted H₂S is scrubbed from the gas stream at 950. Unconverted H₂S is recycled back to the primary regenerator at 960.

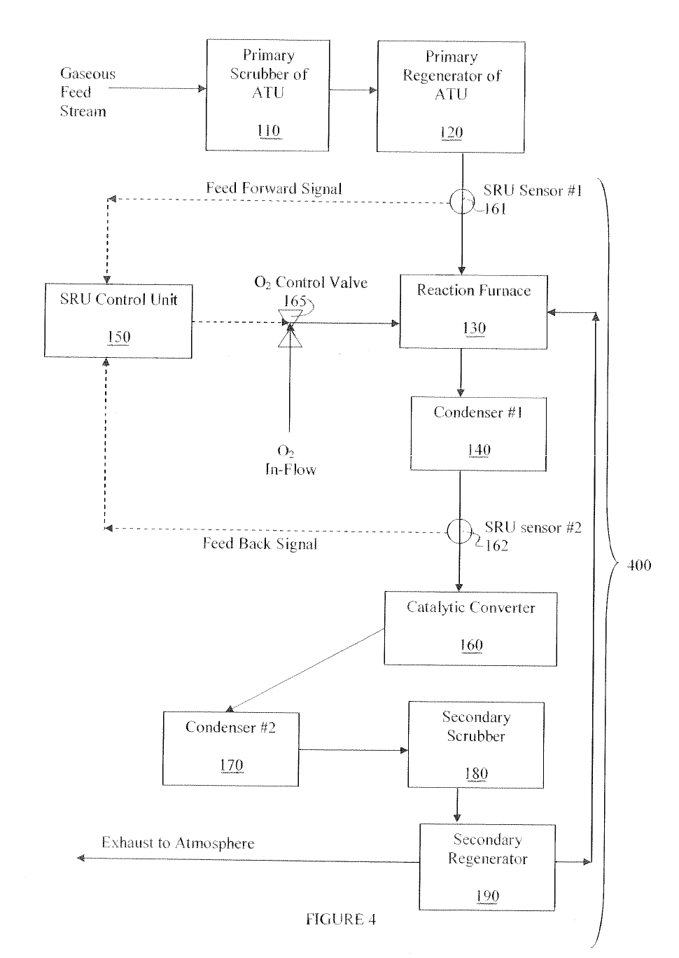

With reference to FIG. 4, in the event that primary regenerator 120 is not available, then, an alternative embodiment would comprise of a secondary regenerator 190 after the secondary scrubber 180, and such that the recycling of the H₂S would be to the reaction furnace 130. Advantageously, secondary scrubber 180 is a smaller and less expensive component than primary scrubber 110 used in the initial stage of the inventive process.

Further, secondary scrubber 180 is incorporated into sulphur recovery unit 400.

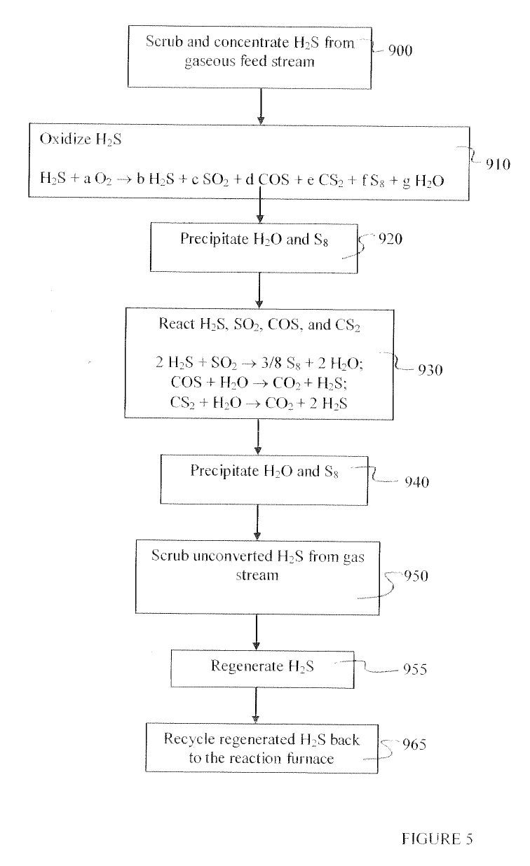

As illustrated in the flow chart of FIG. 5, the process conducted in the system of FIG. 4 comprises scrubbing and concentrating H₂S from a gaseous feed stream at 900. The scrubbed H₂S then is oxidized at 910 according to the present invention. Water and elemental sulphur are precipitated at 920. H₂S, SO₂, COS and CS₂ are reacted at 930. Water and elemental sulphur are precipitated at 940. Unconverted H₂S is scrubbed from the gas stream at 950. Unconverted H₂S can be regenerated at 955 and recycled back to the reaction furnace at 965.

### EXAMPLE 1

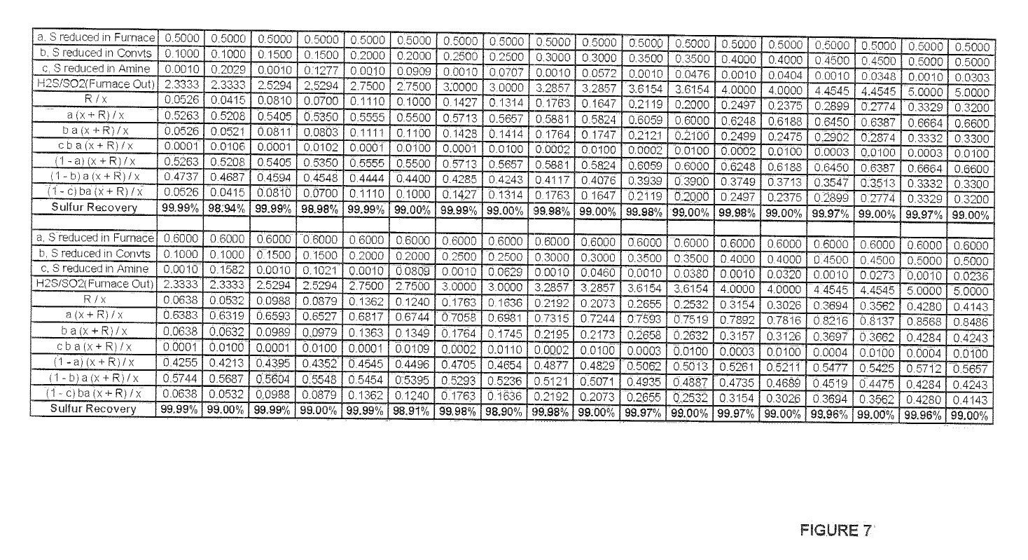

A series of calculations were performed to determine the potential efficiency of a system based on the present invention, including the recycling of untreated H₂S from secondary scrubber 180. The results of these simulations are shown in FIG. 7.

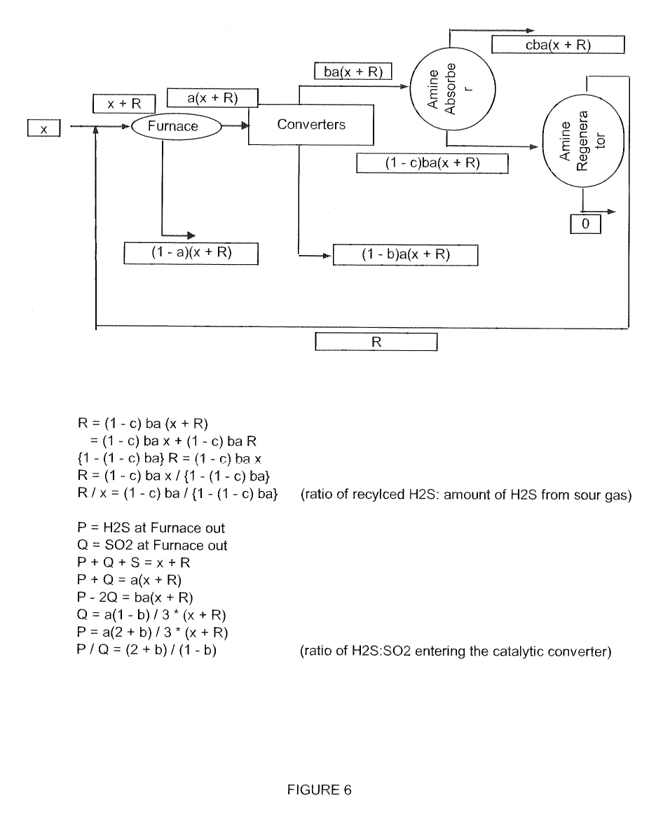

The calculations were based on a schematic diagram representing the preferred embodiment of the present invention (See FIG. 6).

The definitions of the variables used are as follows:

x=amount of sulphur in the primary gas inlet stream (ie. sour gas) entering furnace 140 in moles/hour;

R=amount of recycled H₂S re-entering furnace 130 from secondary scrubber 180 (in reference to FIG. 1) in moles/hour;

P=amount of H₂S leaving furnace 130 in moles/hour;

Q=amount of SO₂ leaving furnace 130 in moles/hour;

S=amount of elemental sulphur that is removed from furnace 130 in moles/hour;

a=efficiency of sulphur recovery in furnace 130, typically between 40-50%;

b=efficiency of sulphur recovery in the catalytic converter, typically between 60-90%; and

c=efficiency of sulphur recovery in the amine scrubber, typically between 90-99.9%.

As shown in the table of FIG. 7, assuming a recovery of sulphur efficiency of 50%, in furnace 130, as the molar ratio between H₂S and SO₂ increase, the efficiency of sulphur recovery varies between 99.0% at the minimum to a maximum of 99.9% recovery. Also accompanying the increase in the stoichiometric ratio between H₂S and SO₂ is the increase in the amount of H₂S that is required to be recycled back to primary regenerator 120.

In accordance with FIG. 7, a molar ratio of 3:1 (H₂S:SO₂), results in an efficiency of 99.9% sulphur recovery. Advantageously, this percentage recovery is far greater than those currently required by environmental regulations in many countries. According to the method of the invention, depriving reaction furnace 130 of oxygen, in any manner that maintains the stoichiometric ratio between H₂S and SO₂ at greater than 2:1, in combination with recycling residual H₂S back to ATU regenerator 120, as taught herein, eliminates the need for and expense of a TGCU, while still meeting or exceeding current environmental standards.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

Although the disclosure describes and illustrates various embodiments of the invention, it is to be understood that the invention is not limited to these particular embodiments. Many variations and modifications will now occur to those skilled in the art of sulphur recovery. For full definition of the scope of the invention, reference is to be made to the appended claims.

What is claimed is:

1. A process for removing sulphurous compounds including H₂S from an industrial gas stream flowing through a fluidly coupled system comprising: a primary scrubber (of a pre-existing amine treating unit), a primary regenerator (of a pre-existing amine treating unit), a reaction furnace, suitable controllers and sensors, at least two condensers, at least one catalytic converter, and a secondary scrubber, the process comprising the steps:
concentrate the H₂S in said industrial gas stream, using a primary scrubber and primary regenerator, so as to create a concentrated gas stream;
feed the concentrated gas stream into a reaction furnace;
combust the concentrated gas stream so as to oxidize H₂S therefrom in said furnace under sufficiently oxygen-deficient conditions so as to maintain a stoichiometric ratio between H₂S and SO₂ to be greater than 2:1;
condense the combusted gas stream so as to precipitate H₂O and elemental sulphur therefrom;
convert the remaining products from the combustion of H₂S to elemental sulphur, using a conventional modified Claus reactor;
condense the catalyzed gas stream so as to further precipitate H₂O and elemental sulphur therefrom;
scrub unconverted H₂S out of the treated gaseous stream; and
recycle any unconverted H₂S to the said primary regenerator.

2. A system for removing sulphurous compounds including H₂S from an industrial gaseous stream flow, the system comprising:
a primary scrubber (of a pre-existing amine treating unit), for scrubbing H₂S from the industrial gaseous stream;
a primary regenerator (of a pre-existing amine treating unit), for concentrating H₂S in the industrial gaseous stream;
a reaction furnace, under sufficiently oxygen-deficient conditions so as to maintain a stoichiometric ratio between H₂S and SO₂ to be greater than 2:1, for the catalytic oxidation of H₂S, sensors and controllers, for sending and receiving feed back and feed forward signals to maintain an oxygen deficient environment in the reaction furnace;
at least two condensers;
at least one catalytic converter;
a secondary scrubber; and
recycling of unconverted H₂S back to the primary generator.

3. The system as claimed in claim 2 further comprising at least two sensors, one sensor for measuring the amount of H₂S entering the reaction furnace and sending a feed forward signal to a controlling unit, and one sensor for measuring the amount of H₂S and SO₂ entering the catalytic converter and sending a feed back signal to the said controlling unit.

4. The system as claimed in claim 2 further comprising a control unit for controlling the amount of O₂ entering the reaction chamber managed by receiving feed forward and feed back signals from at least two sensors.

5. A process for removing sulphurous compounds including H₂S from an industrial gas stream flowing through a fluidly coupled system comprising: a reaction furnace, suitable controllers and sensors, at least 2 condensers, at least one catalytic converter, a secondary scrubber, and a secondary regenerator, the process comprising the steps:
feed the industrial gas stream into a reaction furnace;
combust the industrial gas stream so as to oxidize H₂S therefrom in said furnace under sufficiently oxygen-deficient conditions so as to maintain a stoichiometric ratio between H₂S and SO₂ to be greater than 2:1;
condense the combusted gas stream so as to precipitate H₂O and elemental sulphur therefrom;
convert the remaining products from the combustion of H₂S to elemental sulphur, using a conventional modified Claus reactor;
condense the catalyzed gas stream so as to further precipitate H₂O and elemental sulphur therefrom;
scrub unconverted H₂S out of the treated gaseous stream and concentrate using a secondary regenerator; and
recycle any unconverted H₂S to a reaction furnace.

6. A system for removing sulphurous compounds including H₂S from an industrial gaseous stream flow, the system comprising:
a reaction furnace, under sufficiently oxygen-deficient conditions so as to maintain a stoichiometric ratio between H₂S and SO₂ to be greater than 2:1, for the catalytic oxidation of H₂S,
sensors and controllers, for sending and receiving feed back and feed forward signals to maintain an oxygen deficient environment in the reaction furnace;
at least two condensers;
at least one catalytic converter;
a secondary scrubber;
a secondary regenerator; and
recycling of unconverted H₂S back to the reaction furnace.

7. The system as claimed in claim 6 further comprising at least two sensors, one sensor for measuring the amount of H₂S entering the reaction furnace and sending a feed forward signal to a controlling unit, and one sensor for measuring the amount of H₂S and SO₂ entering the catalytic converter and sending a feed back signal to a controlling unit.

8. The system as claimed in claim 6 further comprising a control unit for controlling the amount of O₂ entering the reaction chamber managed by receiving feed forward and feed back signals from at least two sensors.

9. A process for removing sulphurous compounds from an industrial gas stream containing H₂S comprising:
oxidizing the H₂S in an industrial gas stream in a reaction furnace under sufficiently oxygen-deficient conditions so as to maintain a stoichiometric ratio between H₂S and SO₂ to be greater than 2:1;
condensing the oxidized gas stream so as to precipitate H₂O and elemental sulphur therefrom and producing a condensed gas stream containing at least residual H₂S and SO₂;
catalyzing the condensed gas stream for partial oxidation of H₂S to convert substantially all of the H₂S to elemental sulphur and producing a catalyzed gas stream;
condensing the catalyzed gas stream so as to further precipitate H₂O and elemental sulphur therefrom and producing a treated gas stream;
scrubbing residual H₂S from the treated gas stream through a downstream amine scrubbing unit for producing an exhaust stream unconverted residual H₂S; and
recycling the unconverted residual H₂S to the reaction furnace.

10. The process of claim 9 wherein:
the downstream amine scrubbing unit further comprises a downstream regenerator, and
the recycling of the residual H₂S to the reaction furnace further comprises regenerating the exhaust stream at the downstream regenerator for producing a concentrated residual H₂S and recycling the concentrated residual H₂S to the reaction furnace.

11. The process of claim 9 wherein prior to oxidizing the industrial gas stream, the process further comprises stabilizing the industrial gas stream in a stabilizer.

12. The process of claim 9 wherein prior to oxidizing the industrial gas stream, the process further comprises scrubbing the industrial gas stream for concentrating H₂S by flowing the gas stream through a primary amine treating unit and producing a concentrated gas stream.

13. The process of claim 12 wherein:
the scrubbing of the industrial gas through the primary amine scrubbing unit further comprises regenerating the scrubbed industrial gas through a primary regenerator for further concentrating H₂S in the industrial gas stream, and
the recycling of the residual H₂S to the reaction furnace comprises recycling the residual H₂S to the primary regenerator.

14. A system for removing sulphurous compounds from an industrial gas stream containing H₂S comprising:
a reaction furnace for oxidation of the H₂S under sufficiently oxygen-deficient conditions so as to maintain a stoichiometric ratio between H₂S and SO₂ to be greater than 2:1;
a first condenser for condensing the oxidized gas stream so as to precipitate H₂O and elemental sulphur therefrom and producing a condensed gas stream containing at least residual H₂S and SO₂;
at least one catalytic converter for catalyzing the condensed gas stream for partial oxidation of H₂S to convert substantially all of the residual H₂S to elemental sulphur and producing a catalyzed gas stream;
a second condenser for condensing the catalyzed gas stream so as to further precipitate H₂O and elemental sulphur therefrom and producing a treated gas stream; and
a downstream amine scrubber for scrubbing residual H₂S out of the treated gas stream for producing an exhaust stream and residual H₂S which is recycled back to the reaction furnace.

15. The system of claim 14, wherein the downstream amine scrubbing unit further comprises a downstream regenerator for scrubbing residual H₂S from the downstream amine scrubbing unit and producing a concentrated residual H₂S for recycling back to the reaction furnace.

16. The system of claim 14 further comprising a stabilizer for stabilizing the industrial gas stream for oxidation in the reaction furnace.

17. The system of claim 14 further comprising:
a primary amine treating unit upstream of the reaction furnace for scrubbing and producing a concentrated gas stream for oxidation in the reaction furnace.

18. The system of claim 17 further comprising a primary regenerator for further concentrating H₂S in the concentrated gas stream.

19. The system of claim 14 further comprising: a controlling unit for controlling an amount of O₂ entering the reaction furnace.

20. The system of claim 19 further comprising:
an H₂S and SO₂ sensor for measuring the amount of H₂S and SO₂ entering the catalytic converter and producing a feed back signal; and
wherein the controlling unit for receives the feed back signal for controlling the amount of O₂ entering the reaction furnace.

21. The system of claim 19 further comprising:
an H₂S sensor for measuring the amount of H₂S in the industrial gas stream entering the reaction furnace and producing a feed forward signal and wherein the controlling unit receives the feed forward signal for controlling the amount of O₂ entering the reaction furnace.
